(19) United States
(12) Patent Application Publication
(10) Pub. No.: US 2024/0375529 A1
(43) Pub. Date: Nov. 14, 2024

(54) AUTONOMOUS ELECTRIC CHARGING SYSTEM FOR AN EXTERIOR MOBILE ROBOT

(71) Applicant: Stanley Robotics, Versailles (FR)

(72) Inventors: Aurélien Cord, Paris (FR); Mathieu Lips, Paris (FR)

(21) Appl. No.: 18/249,370

(22) PCT Filed: Oct. 5, 2021
(86) PCT No.: PCT/FR2021/051720

§ 371 Date: Apr. 17, 2023

(30) Foreign Application Priority Data
Oct. 16, 2020 (FR) 2010615

(51) Int. Cl. B60L 53/16; B60L 53/35

(52) U.S. Cl. CPC B60L 53/16; B60L 53/35

(57) ABSTRACT

An electric charging point for an electric vehicle comprises: a support, and, a charging terminal designed for connection to a battery terminal of an electric vehicle in such a way that the contact plane between the two terminals is vertical. The charging point comprises a housing surrounding saidthe support, wherein the housing has a front opening facing the charging terminal, and the housing is movable with respect to the support in a direction perpendicular to the contact plane, between a neutral position in which the opening is located at a neutral distance with respect to the contact plane, and a charging position in which the opening is located at a charging distance with respect to the contact plane. The charging distance is smaller than the neutral distance.

### CROSS-REFERENCE TO RELATED APPLICATIONS

This application is a national phase entry under 35 U.S.C. § 371 of International Patent Application PCT/FR2021/051720, filed Oct. 5, 2021, designating the United States of America and published as International Patent Publication WO 2022/079369 A1 on Apr. 21,2022, which claims the benefit under Article 8 of the Patent Cooperation Treaty to French Patent Application Serial No. FR2010615, filed Oct. 16, 2020.

### TECHNICAL FIELD

The present disclosure relates to the field of charging points for an electric vehicle, preferably for an electric handling vehicle, in particular, for a four-wheeled vehicle transporter or mover.

### BACKGROUND

Patent application DE102009023409 is known in the state of the art and discloses an electric charging point for an electric vehicle, this charging point being connected to a fixed vertical wall via springs. An electric vehicle comprising an electrical contact protection hatch can couple directly with the charging point as soon as the hatch is in the open position.

Also known from the state of the art is patent application U.S. Pat. No. 5,462,439, which discloses an extensible arm for an electric vehicle that provides an electrical connection by coupling with a charging point for an electric vehicle. The arm is extended by a cylinder that is arranged in a casing. The arm moves translatably relative to the casing, which is fixed.

Additionally known from the state of the art is patent application FR3026570,which discloses a cylinder equipped with an extensible arm that provides an electrical connection by coupling a charging point for an electric vehicle to an electric vehicle. The cylinder is arranged in a protective casing on the charging point. The cylinder is mounted slidably relative to the casing. The casing is capable of angular displacement only.

It is nonetheless desirable to improve the protection for the coupling of the electrical elements while providing a solution that is simple and less expensive in terms of both manufacture and maintenance.

### BRIEF SUMMARY

In its most general sense, the present disclosure relates to an electric charging point for an electric vehicle, comprising:
a charging terminal support,
a charging terminal designed for connection to a battery terminal of an electric vehicle, the at least one charging terminal being arranged on the support in such a way that the contact plane between the at least one charging terminal and the battery terminal is vertical,
   characterized in that the charging point comprises a housing surrounding the support, the housing having an opening, referred to as the front opening, facing the charging terminal, the housing being movable with respect to the support in a direction perpendicular to the contact plane, between a neutral position in which the front opening is located at a neutral distance with respect to the contact plane, and a charging position in which the front opening is located at a charging distance with respect to the contact plane, the charging distance being smaller than the neutral distance.

The charging point according to the present disclosure has the advantages of protecting the electrical terminals from spatter or bad weather and of being more economical to purchase and to maintain due to the absence of an actuator. Furthermore, the charging point proposed here can be used in an outdoor environment.

For the foregoing and for the rest of the description, the term “terminal” is understood to mean one or more electrically conductive contacts, or one or more electrical conductors, whether male or female, designed to join or couple with one or more contacts or one or more conductors of the complementary type.

Preferably, the charging point comprises means for translatably guiding the housing (the housing translates along at least one rail). The means for translatably guiding the housing are arranged on either side of the charging terminal support. Advantageously, the means for translatably guiding the housing are rails, and wheels connected to the housing, so that the housing can run along the rails and thus translate relative to the support.

According to one alternative embodiment, the charging point comprises a return means connected to the housing and designed to return the housing to the neutral position when no charging operation is underway or when no electric vehicle is coupled to the charging terminal. Advantageously, the return means comprises at least one spring. It is arranged between the charging terminal support and an inner face of the housing. It extends in a direction parallel to the direction of translation of the housing.

According to one embodiment, the charging point may comprise a flap that is movable between a protection position, in which the flap covers the charging terminal, and a connection position, in which the flap does not cover the charging terminal. This feature strengthens the protection of the electrical contacts of the charging terminal. The flap is arranged inside the housing. In the connection position, the flap is at least partially folded back along a wall of the housing. The charging point comprises connecting means that allow the flap to move relative to the housing.

According to one alternative embodiment, the charging point comprises connecting means between the flap and the housing and guide means such that the movement of the housing causes the flap to move. Preferably, the guide means comprise flap rails arranged on either side of the flap. The guide means comprise vertical and horizontal rails that are arranged fixedly relative to the charging terminal support. The guide means comprise idler wheels that are arranged on the sides of the flap and are designed to be inserted into the flap rails so as to allow the flap to lift and tilt like an up-and-over garage door. The connecting means comprise at least one pivoting mechanical connection between the flap and the housing. Preferably, the connecting means may further comprise a pivoting free wheel borne by a shaft that is fixed relative to the support. The pivoting free wheel is arranged in such a way that the flap tilts in contact with the wheel and moves in the direction of movement of the housing.

According to one embodiment, the flap comprises two horizontal sections. The two horizontal sections are connected to one another by a pivot link.

Preferably, the shape of the opening of the housing is similar to the shape of the battery terminal. The dimensions of the opening are designed so that the battery terminal, which protrudes from a wall of the electric vehicle, can pass through the opening. According to one embodiment, the opening of the housing is rectangular in shape.

According to other alternative embodiments, the charging point may comprise:
a housing bearing surface or area arranged on the housing, the surface being designed to act as a support for the electric vehicle when the vehicle pushes the housing to place it in the charging position,
a shock absorption means arranged between the support and the charging terminal, the shock absorption means corresponding to one or more springs, for example,
a positioning sensor in case of poor positioning of the electric vehicle relative to the charging point.

### BRIEF DESCRIPTION OF THE DRAWINGS

The present disclosure will be better understood from reading the following description, which refers to one non-limiting exemplary embodiment illustrated by the appended drawings, in which:

FIG. 1 shows a schematic side view of an electric charging point according to one embodiment, the charging point comprising a housing in a neutral position and shown in cutaway;

FIG. 2 shows a charging point in accordance with FIG. 1, the housing being in a charging position; and

FIG. 3 shows the front face of a housing according to one embodiment, the housing having an opening.

### DETAILED DESCRIPTION

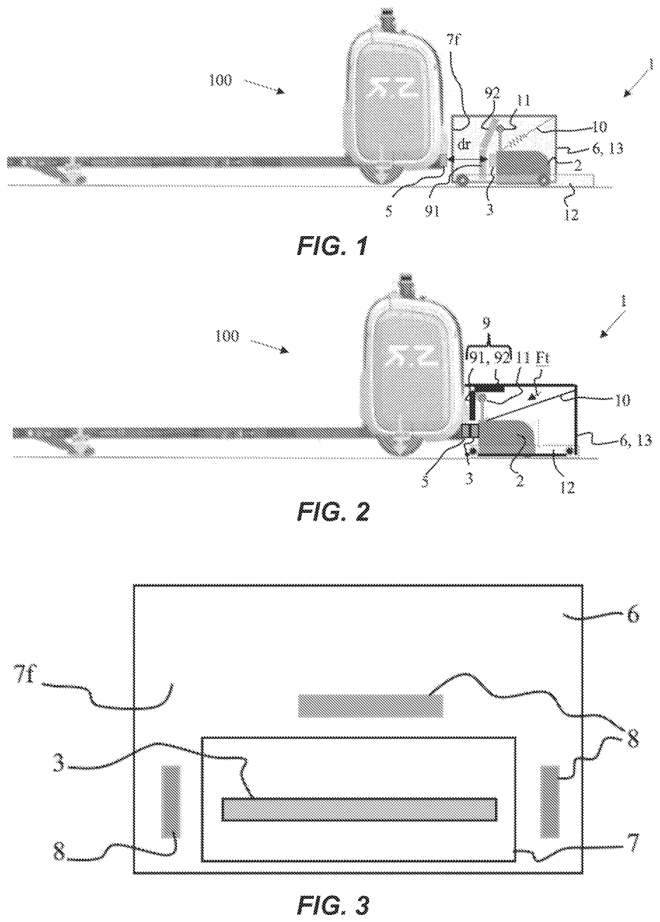

FIGS. 1 and 2 show an electric vehicle 100 positioned in front of or in the charging position with an electric charging point 1. The electric vehicle has a battery terminal 5 for charging its batteries (not shown). The battery terminal 5 is arranged on the front face of the vehicle 100.

The electric charging point 1 comprises a charging terminal support 2, on which is arranged a charging terminal that is designed to be connected to the battery terminal 5 of the electric vehicle 100. With reference to FIG. 2, when the battery terminal 5 is coupled to the charging terminal 3, the contact or coupling plane is vertical.

The charging point 1 comprises a housing 6 surrounding the support. The housing 6 is rectangular in shape. It acts to protect the charging terminal from, in particular, bad weather. With reference to FIG. 3, the housing 6 has an opening, referred to as the front opening 7, made in the front wall 7f of the housing 6. The front opening is designed so as to be located facing the charging terminal. The front opening 7 allows the battery terminal of the electric vehicle to connect directly to the charging terminal 3 of the charging point. The shape of the front opening 7 is rectangular like that of the charging terminal 3. The housing 6 has no other openings besides the front opening 7.

The charging point comprises means for translatably guiding the housing. With reference to FIGS. 1 and 2, the means for translatably guiding the housing are straight rails arranged on either side of the support 2. They allow the housing 6 to translate from a neutral position (see FIG. 1) to a charging position (see FIG. 2). With reference to FIG. 1, the front wall 7f of the housing 6 is located at a neutral distance dr from the contact plane when the housing is in the neutral position. The neutral distance is approximately 50 centimeters, or between 40 and 80 centimeters.

When an electric vehicle charging operation is required, an electric vehicle 100 moves and arrives in front of an electric charging point 1. The vehicle moves forward in a direction perpendicular to the contact plane and/or a direction parallel to the longitudinal direction of the housing 6 until it bears against the front wall 7f of the housing 6. According to one embodiment, illustrated in FIG. 3, the vehicle bears against the wall 7f via bearing surfaces or areas 8 that are arranged on the outer face of the front wall 7f. Finally, the vehicle pushes the housing 6 until the battery terminal 5 is coupled with the charging terminal 3, as shown in FIG. 2. In the charging position, the front wall is less than 10 centimeters away from the contact plane.

The electric charging point 1 comprises a means for returning the housing 6 to the neutral position when an electric vehicle uncouples or disconnects from the charging point. The return means is designed to exert a force on the housing that returns it to the neutral position, represented by the arrow Ft. With reference to FIGS. 1 and 2, the return means is represented by a spring 10. The spring 10 is connected to a first support end 2, and to a second end, opposite the first end, on the rear wall 13 of the housing 6. It may also consist of a cylinder.

Preferably, the electric charging point comprises a flap 9 arranged inside the housing 6. The flap is movable between a protection position (see FIG. 1), in which the flap covers, or is positioned in front of, the charging terminal 3, and a connection position (see FIG. 2), in which the flap does not cover the charging terminal 3.

With reference to FIGS. 1 and 2, the flap 9 comprises two horizontal sections 91, 92 that are connected to one another by a pivot link.

In a manner that is not shown, the electric charging point comprises means for guiding and connecting the flap relative to the support so as to allow the flap to lift and tilt in order to go from the protection position to the connection position, and vice versa. Preferably, the connecting means comprise a pivoting free wheel 11 borne by a shaft that is fixed relative to the support. The pivoting free wheel is arranged in such a way that the flap tilts in contact with the wheel and moves in the direction of movement of the housing.

In addition, the electric charging point comprises connecting means between the flap 9 and the housing 6 such that the movement of the housing 6 causes the flap 9 to move. In particular, the section 92 of the flap is connected to the housing 6.

1. An electric charging point for an electric vehicle , comprising:
a charging terminal support;
a charging terminal designed for connection to a battery terminal of the electric vehicle, the charging terminal being arranged on the support in such a way that the contact plane between the at least one charging terminal and the battery terminal is vertical;
a housing surrounding the support, the housing having a front opening, facing the charging terminal, the housing being movable with respect to the support in a direction perpendicular to the contact plane, between a neutral position in which the opening is located at a neutral distance with respect to the contact plane, and a charging position in which the opening is located at a charging distance with respect to the contact plane, the charging distance being smaller than the neutral distance.

2. The electric charging point of claim 1, further comprising means for translatably guiding the housing.

3. The electric charging point of claim 2, further comprising a return means connected to the housing and configured to return the housing to the neutral position when no charging operation is underway.

4. The electric charging point of claim 3, further comprising a flap, the flap being movable between a protection position, in which the flap covers the charging terminal, and a connection position, in which the flap does not cover the charging terminal.

5. The electric charging point of claim 4, further comprising connecting means between the flap and the housing such that the movement of the housing causes movement of the flap move.

6. The electric charging point of claim 5, wherein the flap comprises two horizontal sections.

7. The electric charging point of claim 6, further comprising a housing bearing surface on the housing.

8. The electric charging point of claim 7, further comprising a shock absorption means arranged between the support and the charging terminal.

9. The electric charging point of claim 8, further comprising a positioning sensor located and configured to sense a position of the electric vehicle relative to the charging point.

10. The electric charging point of claim 1, further comprising a flap, the flap being movable between a protection position, in which the flap covers the charging terminal, and a connection position, in which the flap does not cover the charging terminal.

11. The electric charging point of claim 10, further comprising connecting means between the flap and the housing such that movement of the housing causes movement of the flap.

12. The electric charging point of claim 4, wherein the flap comprises two horizontal sections.

13. The electric charging point of claim 1, further comprising a housing bearing surface on the housing.

14. The electric charging point of claim 1, further comprising a shock absorption means arranged between the support and the charging terminal.

15. The electric charging point of claim 1, further comprising a positioning sensor located and configured to sense a position of the electric vehicle relative to the charging point.
